(19) United States
(12) Patent Application Publication
(10) Pub. No.: US 2020/0284746 A1
(43) Pub. Date: Sep. 10, 2020

(54) ELECTROCHEMICAL SENSOR DEVICE FOR MEASURING THE LEVEL OF THE PULP AND FOAM INTERFACE INSIDE A FLOTATION CELL AND/OR COLUMN, IN A FLOTATION PROCESS, THE CONFIGURATION OF WHICH ALLOWS THE SELF-CLEANING THEREOF

(71) Applicant: HIGHSERVICES TECHNOLOGY & SERVICES LIMITADA, Santiago (CL)

(72) Inventors: Hugo Cesar Salamanca Poblete, Santiago (CL); Guillermo Alejandro Vidal Rudloff, Santiago (CL)

(21) Appl. No.: 16/626,976

(22) PCT Filed: Jun. 28, 2017
(86) PCT No.: PCT/CL2017/050029

§ 371 Date: Apr. 15, 2020

(51) Int. Cl. G01N 27/30; G01N 27/406

(52) U.S. Cl. CPC G01N 27/30; G01N 27/4067

(57) ABSTRACT

An electrochemical sensor device to measure the level of the interface between the pulp and froth in a flotation process is disclosed, as is a related system and method. The device may be used relative to flotation of minerals, and comprises a sensor rod and a housing, wherein the sensor rod is the element inserted into the interior of a flotation cell and/or column, formed by a central carrier, made of electrically insulating material, onto which conducting electrodes are fixed, in the form of rings, arranged alternately with insulating rings, wherein said electrodes are connected to an electrical conductor that extracts the signals from each electrode. Each conducting ring represents a measurement level.

### CROSS-REFERENCE TO RELATED APPLICATIONS

This application is the United States National Stage entry under 35 U.S.C. 371 of PCT International Application No. PCT/CL2017/050029, filed Jun. 28, 2017, the contents of which are hereby incorporated by reference in its entirety.

### DESCRIPTION

### Field of the Invention

The present invention relates to a device for measuring the level of the interface between pulp and froth inside a flotation cell and/or column for concentrating minerals, wherein a preferred form relates to an electrochemical sensor device for measuring the interface between the pulp and froth in a flotation process for minerals.

### Background Art

Flotation is a physico-chemical process that involves three phases, solid-liquid-gaseous, with the purpose of separating mineral species by selective adhesion of mineral particles to air bubbles.

The froth flotation process enables selective separation of hydrophobic from hydrophilic minerals, such that the mineral of interest adheres to air bubbles produced with the involvement of reagents, which draw it with them towards the surface, forming a liquid pulp phase and a froth phase where the mineral of interest is concentrated.

Flotation plants or equipment, or both, comprise at least one flotation cell and/or column wherein the solution (ground mineral, reagents, water) to be treated is prepared, air is fed into this and the contents are mixed to form a mixture of air bubbles and particles of solid material from the solution, forming a layer of froth on top of the liquid pulp, where said froth contains the concentrated mineral, from where it is removed or drained for collection.

The dimensions of a flotation cell and/or column—width, length and height—are known, which also to some degree makes it possible to know the percentages of the two phases that form in a cell in a flotation process, where 80% of its height is liquid pulp and the remaining 20% is froth.

The height relationship between the liquid pulp and the froth is fundamental to optimising the flotation process, because maintaining an optimum height of liquid pulp inside the cell provides for an increase in the amount of the minerals of interest contained in it which are intended to be extracted and separated, thus maximising recovery, while maintaining an optimum height of froth in the flotation cell enables the amount of impurities contained in the mineral concentrate froth to be reduced, thus maximising the cleanliness of the concentrate.

Therefore, being able to control the height at which the interface occurs between the liquid pulp and froth inside a flotation cell, to establish an optimum interface level, is fundamental and of great interest, as when the interface drops below the optimal level, recovery also drops, thus the mineral of interest remains unrecovered, and when the interface level rises above the optimal level, contamination of the recovered mineral of interest increases.

A series of devices, items of equipment, procedures, systems or instruments exist in the art that enable measurement of the level of the interface between the liquid pulp and the froth inside a flotation cell, such as the method that uses the pressure differential between two pressure gauges located at the upper and lower parts of a flotation cell or column, the float method, ultrasonic measurement procedure, method of measuring with conductive/capacitive sensor rods or methods which use acoustic transducers, for example.

An example of a measurement system or procedure, or both, for an interface in a flotation column or cell is disclosed in document CL 201202413 (Outotec Oy) dated 31 Aug. 2012, which describes a method, apparatus and computer program for detecting the locations of the limits between the different materials in a desired measurement volume, using a measuring probe, the electrodes of which are used in combination to form a configuration which deviates from a straight line, where the measurements are made remotely, where the distributions of electrical conductivity in the column of the medium are detected by electrical impedance tomography measurement, enabling the detection of possible limits between different materials or the various thicknesses of layers of different materials.

Another device and method for monitoring the operation of a flotation cell, is disclosed in document WO 2007/048869 (Geologian Tutkimuskeskus Gtk) dated 3 Apr. 2007, which describes a method and a device where the electrical conductivity of the material in the flotation cell is measured in order to observe any variation in the movement, the properties and/or the interior structure of the material, where the device comprises a number of sensors for measuring electrical conductivity, which can be inserted into the flotation cell and embedded in the material.

The solutions in a flotation cell in a mineral concentration process have an alkaline pH, which is normally achieved through the addition of lime. Additionally, the water used in this process comes from environments where the water is hard, i.e., has a high lime content. These environments, to which the sensors for measuring the interface within a flotation column and/or cell are exposed, produce furring and/or the formation of a layer of scale, i.e., a layer of limescale on the measuring surface, which clearly affects the measurement by said device.

There is currently a trend to use sea water in mineral treatment processes to concentrate them. However, sea water is known to have high concentrations of salts and/or chlorine that produce corrosion in the media exposed to it, producing furring in the devices and pipes, as well as all the means and/or elements exposed to it, causing it to produce a layer of scale on the surface exposed to sea water over time. That is, the use of sea water in a flotation process will, over time, cause the devices that measure the solution interface in said flotation cell and/or column to be exposed to the formation of a layer of scale that will need to be eliminated and/or removed.

All of these conditions mean that the medium in which a device is used to measure the interface between pulp and froth in a flotation solution causes furring of the surface of the device in the flotation solution, forming a layer of scale, such as a layer of limescale, on said device. This means that the precision of the measurements made with that device is incorrect, delivering erroneous measurements that lead to erroneous and/or incorrect adjustment operations being performed, to the detriment of productivity and efficiency in a flotation process.

There are a series of publications in the prior art relating to systems and procedures for removing limescale deposits from surfaces. For example, document DE 19957406 (Zeppenfeld Kai), dated 31 May 2001, describes a process for descaling water tanks and pipes in which a copper or stainless steel cathode electrode is introduced and coupled to a 6-12 volt direct current, where the inside face of the tank or pipe acts as an anode, subsequent electrolysis of the water separates calcite, while the H⁺ ion released at the anode lowers the pH, slightly dissolving the innermost layer of the calcium scale, where the bubbles of O₂ generated enable increased release of said inner layer, which falls away and can be removed completely by filtration or sedimentation.

The devices for measuring the interface between the pulp and froth in a flotation cell used in the prior art do not consider, in their operation, the adverse effects produced by a layer of limescale deposited on the measuring surface, which directly affects their accuracy in determining precisely where the interface is located between pulp and froth, producing a distortion in the measurement, affecting process efficiency.

The need exists, therefore, to provide a system, device, apparatus and/or procedure for measuring the interface between pulp and froth in a flotation cell, the configuration of which avoids the measurement being affected by a layer of limescale deposited on the measuring surface. It is desirable for the configuration of a sensor device to measure the interface between pulp and froth in a flotation cell or column to be able to determine with accuracy, precision, and certainty, the location of said interface in a solution of minerals in a flotation cell, in order to maximize mineral recovery and at a lower level of contamination and, at the same time, to be able to eliminate the layer of limescale that is deposited on the measuring surface, without needing to stop the measurement process to maintain and/or clean said device.

### SUMMARY OF THE INVENTION

The primary subject matter of the invention is to provide an electrochemical sensor device, the configuration of which enables precise, accurate measurement of the location of the interface between the pulp and froth of a solution in a flotation cell.

A further subject matter of the invention is to provide systems and/or processes for precisely measuring an interface between pulp and froth in a flotation cell, without said measurement being affected by buildup on the measuring surface, as for example in mineral flotation processes, where layers of limescale are produced on surfaces exposed to the flotation solution.

Yet a further subject matter of the invention is to provide an electrochemical sensor device or procedure, or both, for measuring an interface between pulp and froth inside a flotation cell and/or column, the configuration of which enables the measurement of a dynamic response over time to changes in the electrical stimulus in the medium in which it is located, and at the same time which enables removal or self-cleaning, or both, of the sensor surface exposed to the scaling medium by which it may be affected, to achieve precise, effective measurements to determine said interface.

A further subject matter of the invention is to provide a procedure for the operation of an electrochemical sensor device for determining the interface between pulp and froth inside a flotation cell and/or column, the operation of which will, in a predetermined manner, permit the elimination and/or self-cleaning of a layer of limescale that may be present on the measuring surface, so as to make it possible to prevent and/or minimise stoppages for maintenance and/or cleaning to which said device needs to be subjected, to achieve precise and/or effective operation over time.

To achieve said results, the invention consists of an electrochemical sensor device to measure the level of the interface between the pulp and froth in a flotation process, such as, preferably, in the form of flotation of minerals, comprising a sensor rod and a housing, wherein the sensor rod is the element inserted into the interior of a flotation cell and/or column, formed by a central carrier, made from an electrically insulating material, onto which conducting electrodes are fixed, in the form of rings, arranged alternately with insulating rings, wherein said electrodes are connected to an electrical conductor that extracts the signals from each electrode, and the main housing is sealed against moisture and contamination, and which has internal electronics and a base which supports the sensor rod. Each conducting ring represents a measurement level, which when stimulated as a consecutive pair react by sending a response which is measured and analysed to determine whether the content inside the cell is pulp or froth, and where each point on the electrodes where said electrical stimulation occurs produces micro-electrolysis that enables it to lift the layer of calcite which may be present on the electrode surface, to avoid distortion in the measurement of the response to the electrical stimulation applied to each of the electrodes over time.

In addition, the electrical stimuli applied under a predetermined operating condition of the electrodes, which includes the sensor rod, enable it to perform a generalized cleaning process of the surface thereof to achieve the elimination of the layer of limescale which may be deposited on the sensor rod surface, the basis of which is electrolysis.

### DESCRIPTION OF THE DRAWINGS

To help to improve understanding of the features of the invention, according to a preferred practical embodiment thereof, accompanying as an integral part of said description is a set of drawings, of an illustrative, non-limiting nature, representing the invention.

FIG. 1 presents a side perspective view of the electrochemical sensor device of the present invention.

FIG. 2 presents a side view of the electrochemical sensor device of the present invention.

FIG. 3 presents an enlarged side view of a portion of the sensor rod or probe of the electrochemical sensor device of the present invention.

FIG. 4 presents an enlarged side perspective view of an exploded view of part of the sensor rod or probe shown in FIG. 3.

FIG. 5 presents an enlarged perspective view of an exploded view of a section of the sensor rod or probe of the electrochemical sensor device of the present invention.

FIG. 6 presents an enlarged side view and perspective view of an electrode ring unit of the electrochemical sensor device of the present invention.

FIG. 7 presents a perspective view of an electrode ring unit of the electrochemical sensor device of the present invention.

FIG. 8 presents a side view and a perspective view of a longitudinal cross-section of a portion of the sensor rod of the electrochemical sensor device of the present invention.

FIG. 9 presents a side view of a portion of the sensor rod of the electrochemical sensor device representing the furring that forms on the surface of the rod and its detachment.

FIG. 10 presents a perspective view of an exploded view of the control unit for the electrochemical sensor device in a first embodiment of the present invention.

FIG. 11 presents a perspective view and an exploded view of the control unit for the electrochemical sensor device in a second embodiment of the present invention.

FIG. 12 presents a perspective view of a flotation cell representing the form in which the electrochemical sensor device is disposed inside said cell.

### PREFERRED EMBODIMENT OF THE INVENTION

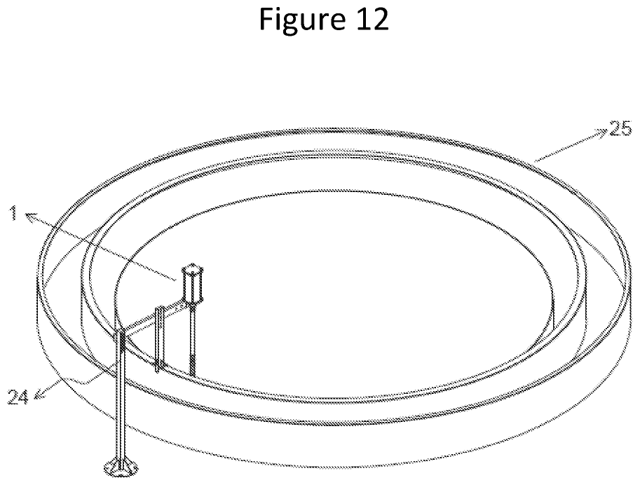

The electrochemical sensor device (1) comprises, as basic elements, a sensor rod or probe (2) and a control unit (3), joined together, such that the sensor rod or probe (2) can be disposed, inserted and/or maintained in a flotation cell, to be able to measure the level of the interface between pulp and froth, as shown in FIG. 12.

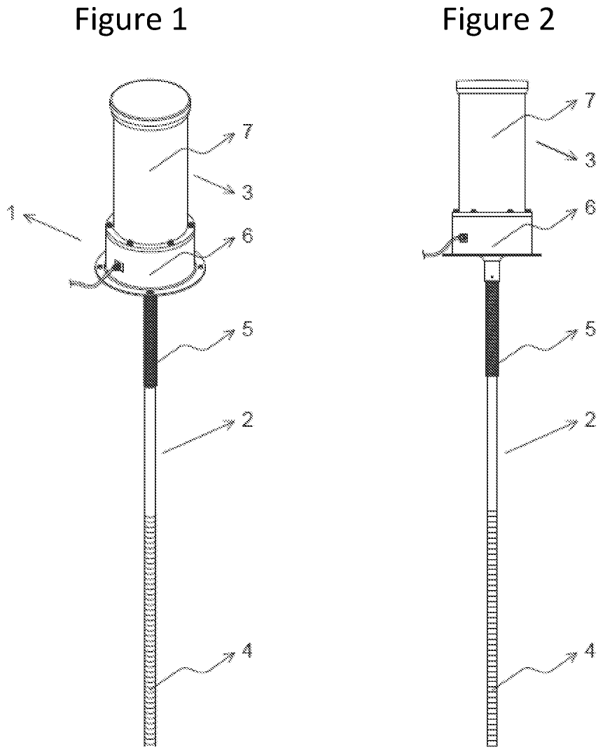

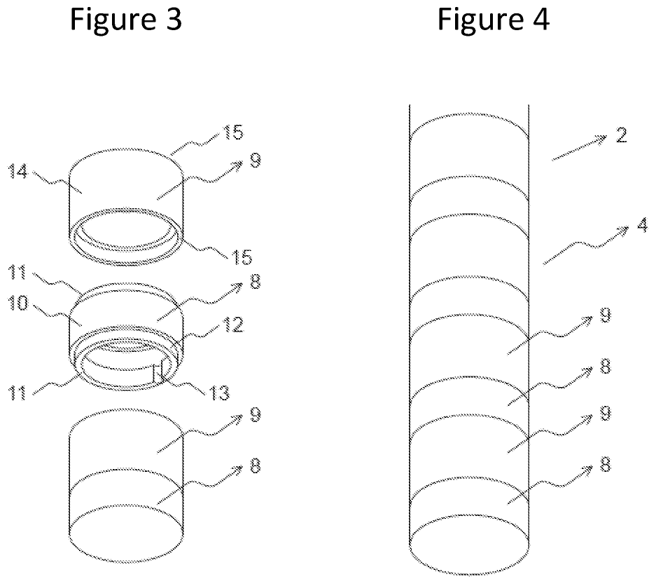

By way of example, in a preferred embodiment, as illustrated in FIGS. 1 and 2, the sensor rod or probe (2) is formed of a series of rings (4) and a shaft (5) which is attached to a base (6), which comprises the control unit, which also comprises a housing or cover (7) fixed in a sealed form to said base (6).

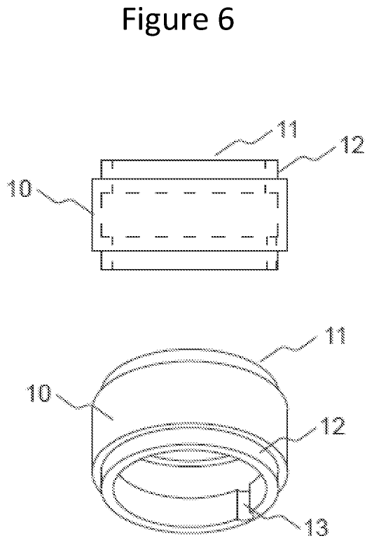

With reference to FIGS. 4 to 8, in a preferred embodiment of the electrochemical sensor device of the present invention, the sensor rod or probe (2) is configured by a series of rings (4) joined together, which comprises conducting rings and/or electrodes (8) and insulating rings (9). The conducting rings or electrodes (8) are configured using electrically conductive materials to function as electrodes. Said electrodes are preferably formed of a hollow annular cylindrical body (10) with ends (11) machined around the entire periphery of the body, to form joining means (12), such as flanges for example, which allow them to be joined to the insulating rings (9), and wherein they have a groove (13) in the interior part of their body (see FIGS. 4, 5 and 6).

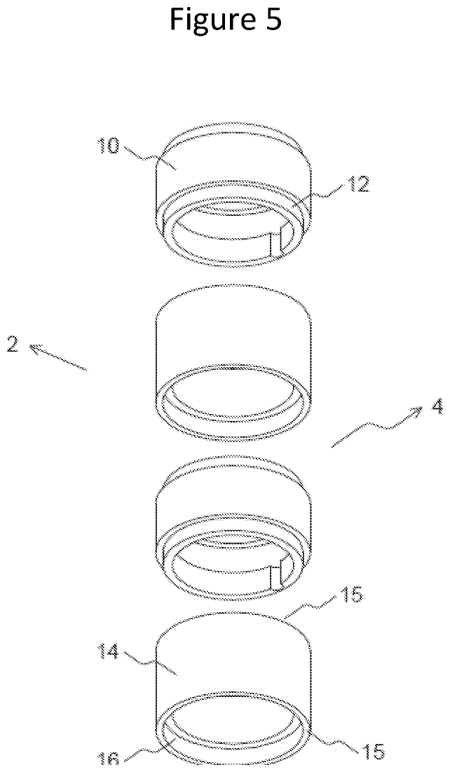

The insulating rings (9) are configured using materials that make it possible to insulate two conducting rings arranged adjacent to each other, in such a way as to keep them at a predetermined distance from each other, in the configuration of the sensor rod or probe (2), wherein said insulating rings comprise a hollow annular cylindrical body (14) which has ends (15) machined to form joining means (16) in such a form as to match and to enable receipt of the joining means (12) of the conducting rings (8), to enable them to be joined to each other (see FIGS. 4 and 5).

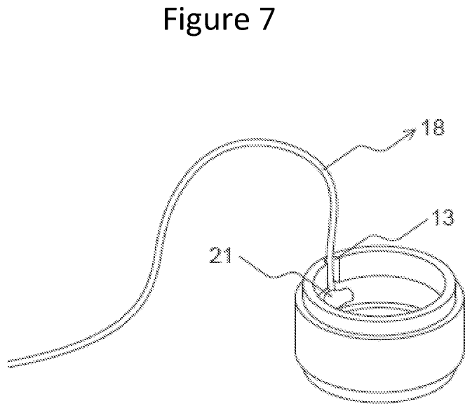

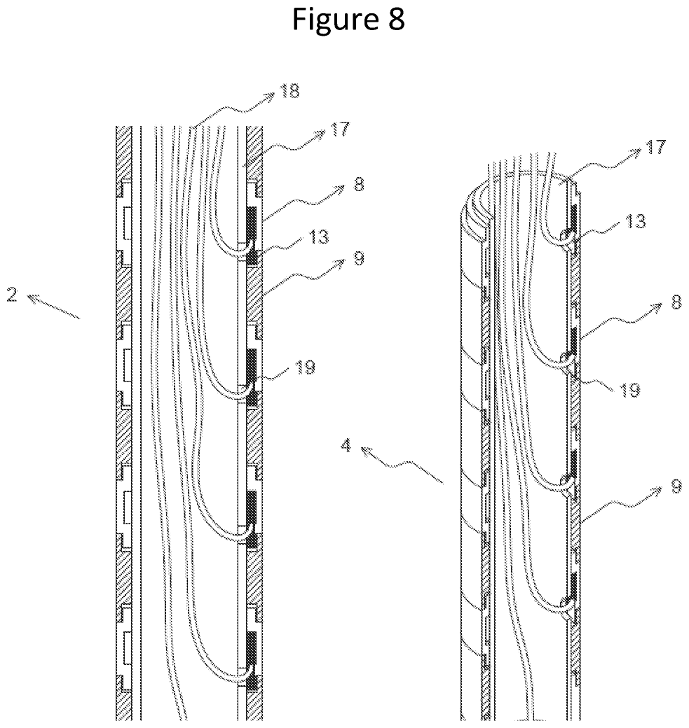

As shown in FIG. 8, the sensor rod or probe (2) comprises at least one carrier means (17), in the form of at least one circular annular hollow body made from an electrically insulating material, on which are arranged and/or fixed at least one conducting ring (8) and at least one insulating ring (9), in such a way that these rings are joined to each other adjacently by means of the respective joining means (12, 16) of each of said rings. Each at least one conducting ring (8) is connected to at least one electrical conductor wire (18), where the interior groove allows the cable to be securely housed to be inserted through the at least one orifice (19) made in said at least one carrier means (17), such that it can be guided and disposed securely through the hollow centre of the carrier means to the control unit (3), as illustrated by way of example in FIGS. 7 and 8. The sensor rod also comprises at least one portion or shaft (5) by means of which it can be joined to the control unit, where in one embodiment said portion or shaft (5) of the rod comprises at least one threaded portion (20). Furthermore, said shaft may also include at least one reinforcement which enables it to strengthen and provide support to the upper part of the sensor rod when this is connected.

The at least one conductor wire (18) which is fixed to the at least one conducting ring or electrode (8) can be fixed directly to the inner surface of the ring body, such as, for example, by soldering (21) (FIG. 7). Also, a platen or plate can be soldered to the inside surface of the body of the conducting ring or electrode (8) and the conductor wire can be attached to this. The material of the conductor wire, as well as that of the platen or plate, must be of high conductivity, such as copper, for example.

Each conductor wire (8) which the sensor rod comprises, which is attached to each of the conductor rings, runs to the part where it is attached to the control unit (3), with each wire terminating in a connector connected to said control unit.

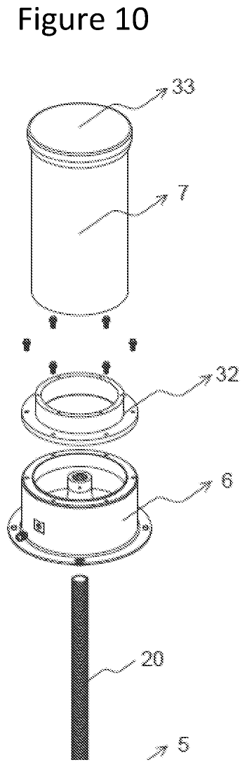

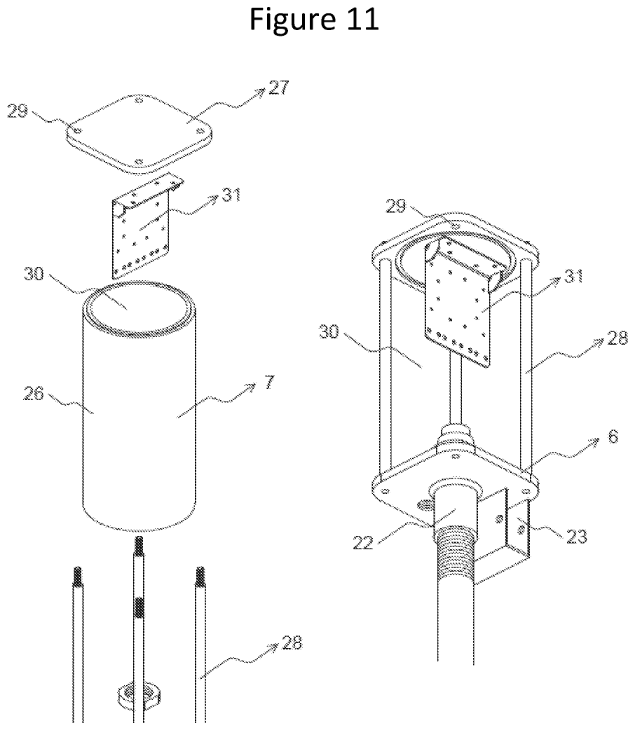

With reference to FIG. 11, the control unit (3) comprises at least one housing and/or cover (7), attached in a sealed manner to the at least one base (6), where said at least one base comprises means and/or elements (22) to secure the shaft (5) of the sensor rod to said at least one control unit (3). Furthermore, the at least one base has at least one joining and/or support means and/or element (23) to fix the at least one retention and/or bracket system (24), which enables it to locate and support the electrochemical sensor device (1) in the at least one flotation cell (25), as shown in FIG. 12, by way of example. The housing and/or cover comprises at least one casing (26) which is disposed on and/or fixed on top of the control unit base (6), where the support of said casing can also be achieved by means of at least one means or element of attachment that projects from the base, such as fixing rods (28) with threaded ends, which can be fixed in fixing holes (29) in the at least one lid (27) which can comprise the control unit housing and/or cover (7), in such a manner that the joining or fixing between said components allows an internal housing compartment (30) to be formed, in which the electronic components that form the control unit are disposed, supported and/or fixed. As shown in FIG. 10, another form of joining the base to the control unit housing could be a joining means (32) between said elements, where a form of maintaining the inside of the housing sealed and hermetic could apply by means of the use of a cap (33).

The control unit comprises a control board (31), which can be arranged and supported within the housing compartment (30), where the electronics thereof may include, by way of example, at least one control block, at least one communications block, at least one signal multiplexing block or at least one power supply block or any combination thereof. The control block is a microcontroller-based circuit with a variety of internal peripherals, the purpose of which is to permit system communications and measurement. The communications block is a circuit for external communication of the measurement data and local diagnostics. The signal multiplexing block permits definition of the passage of current between two electrodes and the definition of measurement currents and cleaning currents. The power supply block is responsible for providing the operating voltages and also includes electrical protections for the processing board. The control unit (3) can be connected to a computer to control said unit and for proper operation of the device in general.

The materials for manufacture of the electrodes or conducting rings must be electrically conductive, preferably being manufactured in stainless steel, graphite, titanium or a combination thereof, among other electrically conductive materials. The insulating rings or the means of support for the sensor rod, or both, can be made of any material that enables insulation of electrical conductivity, for example, produced preferentially in PVC, PE, PP or a combination of these, among others. The use of resins is considered in the manufacture of the sensor rod, to seal its interior and protect the wires, and the use of glues is considered to bond the conductive and non-conductive materials together, as well as glues to bond PVC, as well as to bond PVC to steel or other types of metal, or electrical components such as graphite. The shaft of the sensor rod can be manufactured in stainless steel to provide greater rigidity to the fixing of the sensor rod in its joint to the control unit.

In operation, the electrochemical sensor device (1) is arranged, anchored or supported on the structure of at least one flotation cell (25), in such a way as to be supported and/or retained by the retention and/or bracket system (24), secured to the joining means (23) comprising the control unit base (6), such that said control unit is disposed over and at a distance from the upper edge of the flotation cell, to prevent it from being exposed to contamination and/or moisture, and in such a way that the sensor rod (2) is disposed and/or is inserted in the flotation cell, i.e. in the solution contained in said cell to measure its interface between froth and pulp.

The electrochemical sensor device (1) is operated by means of electrical stimulation of at least two contiguous electrodes or conducting rings (8) separated by at least one insulating ring (9), to measure the transient or dynamic response, or both, of the medium in which the electrodes are located, to changes of stimulus. According to the above, the result of the operating mode is detection by electrochemical sweep, such that routing the circuit to each electrode of the sensor rod (2), a voltage waveform is injected and the form of the current flowing between a pair of contiguous electrodes is measured, where the current waveform measured is different between the pulp and froth content. The RMS value of the current waveform is calculated using an algorithm and this value as a result is associated with pulp or froth.

The measurement between electrodes has the limitation of the height and distance between said electrodes, with the measurements varying in multiples of the distance between electrodes, which can be improved by using the interpolation between levels, which is based on the fact that the variation in the current measured between electrodes decreases approximately linearly. This type of measurement enables the use of measurements from adjacent or contiguous electrodes that detect the level change, thus managing to estimate the height of the pulp between levels. Preferentially, the distance between electrodes varies between at least 1.5 cm and at least 4.5 cm, which can correspond to the size of the insulating rings.

The shape of the electrodes, as well as the size of them, is essential for the resolution of the measurement, in which preferentially the at least one electrode that the electrochemical sensor device of the present invention comprises is in ring form, such as to provide a level surface without points, to avoid charge accumulation effects, as well as making the sensor rod robust. The size of the at least one electrode is inversely proportional to the measurement resolution. However, it is proportional to the result of a good soldered joint on the conductor wire, thus it must be of a size to enable its performance to be maximised depending on each of said parameters which directly condition the measurement resolution. Preferably, the size of at the least one electrode varies between at least 1 cm and at least 1.5 cm in height.

By way of example, in a form limiting an operating process, for the electrochemical sensor device of the present invention, for measuring the interface between pulp and froth in a flotation column and/or cell, it comprises the steps of providing an electrochemical sensor device, disposing, fixing and/or supporting said sensor device in a flotation cell and/or column, activating a device control system to control the device, generating an electrical stimulus in at least each electrode the device comprises, for a predetermined period of time, at a predetermined voltage and current, measuring the dynamic response over time of a change in the electrical stimulus applied in an electrode in the medium in which it is located, sending the measurement value and/or information to a controller processor, processing the measurements made by means of the electrodes the device comprises, determining the location of the interface between pulp and froth inside the flotation column and/or cell.

A system for measuring the interface between pulp and froth in a flotation process within a flotation cell and/or column, by means of an electrochemical sensor device, comprises an electrochemical sensor device according to the present invention, a support system for disposing the sensor inside a flotation cell and/or column, a sensor rod or probe, a control device having a control unit to activate and/or deactivate the measurement in a sensor rod, as well as to activate and/or deactivate a cleaning mode of the electrochemical sensor device, a data transmission system, and at least one controller which comprises a program that receives, processes and/or transmits the data and orders for measurement and/or cleaning of the sensor device, according to preset parameters.

The configuration of the electrochemical sensor device, which is formed by a rod that comprises a series of contiguous insulated electrodes arranged alternately on an insulated central carrier at a predetermined distance, and with a predetermined electrode size, makes it possible to precisely measure the location of the dynamic response over time of a change in the electrical stimulus applied in an electrode in the medium in which it is located, where the measurement precision is directly conditioned by the size of each electrode which the sensor rod comprises and the distance between the electrodes which form said rod. Added to the above is the cleaning of the measurement and/or electrically stimulated surface, which is normally exposed to limescale or layers of calcite which affect and distort the measurement location according to the medium in which it is located.

The configuration of the electrochemical sensor device (1) enables it to have self-cleaning features, with respect to the layer of calcite which generally deposits on the surface of same.

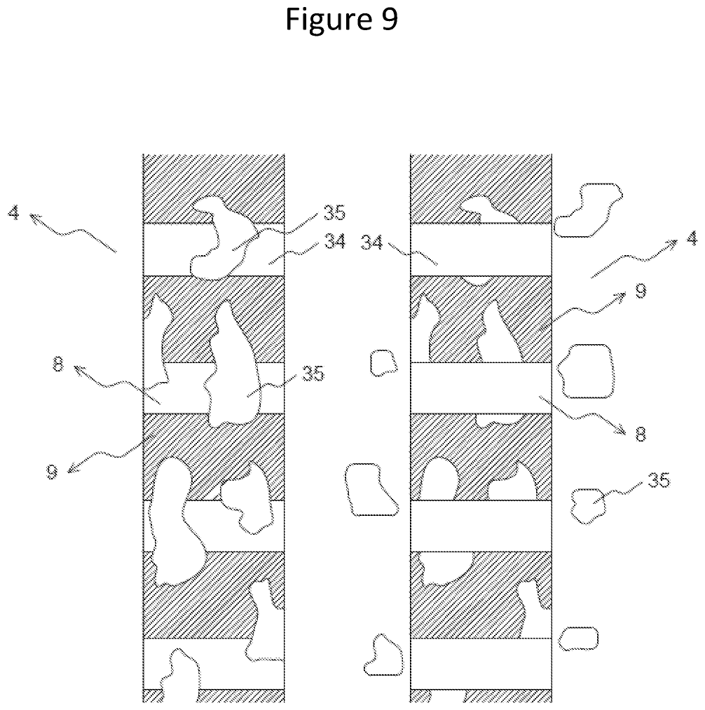

The procedure or operation for self-cleaning the surface exposed to the layer of calcite occurs under two conditions; a first condition characterised by a micro-electrolysis that occurs due the electrical stimulus in the electrode for measurements; and a device self-cleaning operation process, which considers a series of stages under certain conditions and parameters, which enable the generation of electrolysis through all the electrodes, enabling the disintegration or separation of the layer of calcite (35) from the surface (34) that is exposed to the environment of the electrodes (8) the sensor rod (2) comprises, as shown by way of example in FIG. 9.

As a result, the configuration of the electrochemical sensor device of the present invention allows it to measure the transient or dynamic response over time of the environment in which the electrodes are located to changes in the stimulus, where the dynamic response enables clear identification of whether the medium in which the electrodes are immersed is a sector with pulp or froth content, where the interface can be identified clearly.

In addition, the electrical stimulus to said electrodes generates micro-electrolysis of the water, splitting it into oxygen and hydrogen, which occurs on the active surface of the electrodes, but under the layer formed by the limescale deposits, causing the released oxygen to produce bubbles at said active surface, lifting said layer and detaching it from said surface, thus achieving self-cleaning of the sensor, maintaining optimum electrode operation during the measurement operation to determine the interface, which helps to improve measurement precision. Additionally, a specific operation of the electrochemical sensor device enables self-cleaning of said device, on the basis of electrolysis, over a certain period of time, by means of electrical stimulation of the electrodes of which the sensor rod is comprised, achieving separation of the layer of calcite that can deposit on the surface of the sensor rod, thus providing maintenance-free operation of the electrochemical sensor device, keeping the surfaces of the electrodes clean and/or free from limescale at all times.

### APPLICATION EXAMPLE

A series of laboratory level trials were performed to enable determination of the configuration of the device of the present invention, where the initial tests involved measuring the current in a pair of electrodes under different conditions, such as air, froth and a solution, for example. A square pulse was applied to the pair of electrodes, as illustrated in chart No. 1 below, at approximately at least ±3 [V] and at least 50 [Hz] between electrodes, where approximately at least 0.14 [mA] was measured in air, approximately at least 5 [mA] in froth and approximately at least 70 [mA] in water, enabling adjustment of the electronic circuit for the electrochemical reaction, under the different conditions of the medium in which it was located, to thus determine the control parameters between the reactions in each of said states of the medium, enabling clear identification of the liquid and/or froth phases.

Chart No. 1 shows the square pulse applied to a pair of electrodes for current measurement in air, froth and solution.

The device of the invention was used industrially, where said device comprises a configuration as described by way of example in the present invention, incorporating as basic units the sensor rod and a control unit, as illustrated by way of example in FIGS. 1 and 11. The sensor rod consists of at least 1 pair to at least 16 pairs of electrodes separated from each other by means of an insulating ring, being arranged on an insulating carrier body. The applied voltage is in the range of approximately at least ±4 to at least ±6 [V] at approximately at least 50 [Hz] to at least 150 [Hz], with a current of approximately at least 500 [μA] in mineral pulp and at least approximately between 100 and 500 [μA] in froth.

The process for determining the interface between the mineral pulp and froth by means of the device of the present invention considers the use of a circuit comprising a multiplexer, to supply a current stimulus to the electrodes, directed at two contiguous electrodes, i.e., according to a series of electrodes defined by means of the relationship N, N+1, by injecting the electrical stimulation in the form indicated in chart No. 1. The reaction to the stimulus, i.e. the current in the circuit, is measured by means of a measuring circuit, which sends the measurement value and/or information to a controller processor, which routes the information to the multiplexer and/or delivers it to a control system. The RMS current in the pair (N, N+1) is calculated, running from electrode 1 to at least electrode 32, saving the data in the memory and displaying the information, which by way of example is a result as shown in chart No. 2.

Chart No. 2 shows the results from measurement by the device of the invention in a mineral flotation cell and/or column.

The measurements made in the various electrodes, according to the procedure explained above, show that a drop occurs in the [Hz] measured in pair of electrodes 4-5, within a range of approximately at least 8% to at least 10%, where this result, when compared to the program control parameters, shows the interface that occurs between the pulp and the froth. The data obtained from the measurement also show a measurement drop between electrode pairs 6-7 to 12-13, indicating that the froth, which is in the column at that location above the interface, has a higher mineral content, being less transparent, and where the measurement rises subsequently between pairs 12-13 to 19-20 indicating that the froth content has lower mineral content, being more transparent (see chart No. 3).

Chart No. 3 shows the interpretation of the results obtained by means of measurement from the electrodes of the device of the present invention.

On knowing the conditions inside a mineral flotation cell and/or column, point by point, the interface between pulp and froth can be identified clearly and precisely, as can the type of froth, which is achieved by knowing precisely the distance between electrodes, as well as their dimensions and the measurement of interpolation between electrodes.

According to the above, it is clearly demonstrated that the electrochemical sensor device of the present invention enables, on knowing the dimensions of a flotation cell or column—width, length and height—clear, precise establishment of the point and/or location of the interface, thus making it possible to determine the percentage of the two phases that form within a cell and/or column in the flotation process, enabling control, adjustment and/or maintenance of an optimum liquid pulp height within the cell, increasing the amount of minerals of interest contained within it, which are intended to be extracted and separated, thus maximising recovery, while controlling, adjusting and/or maintaining an optimum froth height inside the flotation cell, decreasing the amount of impurities contained in the mineral concentrate froth, thus maximising the cleanliness of the concentrate.

The process of cleaning the device and/or electrodes which the device of the present invention comprises is based on electrolysis of water, enabling the removal of residues adhered to the surface of same.

To perform said process, the device is run through a cleaning program that operates by means of a cleaning circuit, where a pair of contiguous electrodes, which are operated with at least one electrode as an anode and at least one other electrode as a cathode, are operated for a predetermined period of time, said stage being performed with at least all the pairs of electrodes which the at least one sensor rod of the electrochemical sensor device comprises.

Cleaning is performed by means of cleaning cycles that vary in time over a range from at least 10 to at least 16 minutes, in at least a voltage range of at least 1 [V] to at least 5 [V], and at least a current that varies in at least a range from at least 20 [mA] to at least 50 [mA]. The cleaning process may also involve reversing the polarity between at least one pair of electrodes in at least one cycle that varies between at least 1 second to at least 8 seconds, for at least one pair of electrodes.

As a result of this cleaning process, the positive electrode (anode) produces gaseous oxygen (O₂), which applies pressure to the layer of calcite deposited on the surface of the electrode, and ionised hydrogen (H⁺) in water, which dissolves the layer of calcite, and where the negative electrode (cathode) produces hydrogen gas (H₂) and the aqueous hydroxyl anion (OH⁻).

This micro-electrolysis process defined by each of the electrical stimuli to each electrode to obtain measurements, during the measurement processes to determine the interface between pulp and froth, and the generalised process for cleaning the sensor rod by means of electrolysis, detaches the layer of calcite deposited on the surface of said rod, thus managing to keep the measuring surface clean, enabling prevention and/or minimisation of stoppages due to maintenance and/or cleaning to which said device needs to be subjected, in order to achieve precise and/or efficient operation of said device over time.

While the form and configuration of the electrochemical sensor device described herein constitutes a preferred embodiment of this invention, it must be understood that the invention is not limited to this precise form and configuration of electrochemical sensor device, and that changes may be made to it without departing from the scope of the invention, as defined in the attached claims.

1-25. (canceled)

26. A system for measuring the location of the interface between pulp and froth in a floatation solution comprising:
a control unit for generating an electrical stimulus through a plurality of conductive wires and for receiving information from a plurality of sensors;
an electromechanical sensor assembly, said assembly comprising a plurality of rings surrounding a rod disposed in a container for containing a solution, said plurality of rings alternating between conducting rings including sensors and insulating rings with each said conducting ring associated with at least one conductive wire leading to said control unit; and
a processing unit for processing data received from said control unit;
wherein said conducting rings are configured for receiving an electrical stimulation from said control unit, for delivering to said control unit a measure of a response to said stimulation, and for self cleaning following measurement, and said processing unit is configured to determine the location of the interface between pulp and froth based on collective measurements.

27. The system of claim 26, wherein said electrical stimulation is based upon a predetermined voltage waveform.

28. The system of claim 27, where the applied voltage is in the range of ±4V to ±6 V at a range of 50 Hz to 150 Hz with a current of 100 μA to 500 μA.

29. The system of claim 26, wherein said processing unit determines the location of the interface based on a calculated root mean square (RMS) value.

30. The system of claim 26, wherein said conducting rings are formed, at least in part, of stainless steel, graphite, or titanium.

31. The system of claim 26, where the linear distance between consecutive rings is predetermined.

32. The system of claim 26, where said control unit is configured for delivering said electrical stimulation to two consecutive conducting rings at a time.

33. The system of claim 26, where said control unit further includes a signal multiplexing block for delivering electrical stimulations to a plurality of conducting rings.

34. The system of claim 26, where said control unit is configured for delivering a stimulation for a defined time frame.

35. The system of claim 26, wherein said processing unit determines the location of the interface based upon current difference measurements of successive conductive rings.

36. The system of claim 26, where said cleaning is directed to electrical stimulation for removing deposits.

37. A method for a processing unit to determine the location of the interface between pulp and froth in a floatation solution comprising the steps of:
using an electromechanical sensor assembly, said assembly configured to include a plurality of rings surrounding a rod disposed in a container for containing a solution, said plurality of rings alternating between conducting rings including sensors and insulating rings with each said conducting ring associated with at least one conductive wire leading to said control unit, delivering an electrical stimulation to successive conducting rings and receiving a response measurement therefrom;
repeating the delivery of electrical stimulation until there is an adequate current difference measurement between successive conductive rings; and
delivering a further electrical stimulation to each conductive ring adequate to clean said ring by removing deposits.

38. The method of claim 37, where the linear distance between consecutive rings is predetermined.

39. The method of claim 37, where said control unit is configured for delivering said electrical stimulation to two consecutive conducting rings at a time.

40. An electromechanical sensor assembly for measuring the location of the interface between pulp and froth in a floatation solution comprising:
a control unit for generating an electrical stimulus through a plurality of conductive wires and for receiving information from a plurality of sensors;
a rod with structure for configuring said rod vertically, said rod disposed in a container configured for containing a solution; and
a plurality of rings surrounding said rod, said plurality of rings alternating between conducting rings including sensors and insulating rings with each said conducting ring associated with at least one conductive wire leading to said control unit;
wherein said conducting rings are configured for receiving an electrical stimulation from said control unit, for delivering to said control unit a measure of a response to said stimulation, and for self cleaning following measurement, and said assembly being in communication with a processing unit, said processing unit configured to determine the location of the interface between pulp and froth based on collective measurements.

41. The sensor assembly of claim 40, wherein said electrical stimulation is based upon a predetermined voltage waveform.

42. The sensor assembly of claim 40, wherein said conducting rings are formed, at least in part, of stainless steel, graphite, or titanium.

43. The sensor assembly of claim 40, where the distance between consecutive rings is predetermined.

44. The sensor assembly of claim 40, where said control unit is configured for delivering said electrical stimulation to two consecutive conducting rings at a time.

45. The sensor assembly of claim 40, where said control unit is configured for delivering a stimulation for a defined time frame.
